(19) United States
(12) Patent Application Publication
(10) Pub. No.: US 2007/0156622 A1
(43) Pub. Date: Jul. 5, 2007

(54) Method and system to compose software applications by combining planning with semantic reasoning

(76) Inventors: Rama K. Akkiraju, Yorktown Heights, NY (US); Richard T. Goodwin, Dobbs Ferry, NY (US); Anca-Andreea Ivan, New Rochelle, NY (US); Biplav Srivastava, Noida (IN); Tanveer F. Syeda-Mahmood, Cupertino, CA (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/325,902

(22) Filed: Jan. 5, 2006

(51) Int. Cl. G06N 5/02

(52) U.S. Cl. 706/48

(57) ABSTRACT

A system and method for composing application services includes an indexing module configured to index words in a request and available application descriptions to create a semantic similarity map. A semantic matcher is configured to determine semantic similarity between concepts/terms in both domain-independent and domain-specific ontologies for the semantic similarity map. A prefiltering module is configured to determine candidate compositions for the request based on the semantic similarity map and the available descriptions. A metric guided composition method is configured to run algorithms to generate a set of alternative compositions by determining which applications can be composed with which others using the semantic similarity map.

### BACKGROUND

1. Technical Field

The present invention relates to automatic generation of software compositions, and more particularly to systems and methods that combine domain-independent cues with domain-dependent cues in an algorithmic approach to generate software application compositions.

2. Description of the Related Art

A problem exists for identifying appropriate software applications for implementing a required function from a large collection of available applications. The problem may typically arise in enterprise integration projects where new and modified business applications need to be implemented and integrated to support new business processes, and there is a desire to reuse existing applications whenever possible. Specifically, in the context of a large enterprise, typical systems are developed over different periods of time, for different purposes, by different organizations or units and with different structures and vocabulary. This leads to substantial heterogeneity in syntax, structure and semantics of application interfaces of application interfaces.

This necessitates the need for good tools that can help in performing a search for suitable application interfaces. To be useful, the tools have to be able to resolve the syntactic and semantic differences of application interfaces in determining matches. Moreover, in cases where a single application interface cannot match a given request, the applications have to be able to suggest compositions of applications to match the request. For example, one application A needs signed and encrypted documents while another application, B, which needs to be integrated with A, can only supply plain text documents. In such cases, digital signing application D and encryption application E can be composed with B to match A (i.e., the composition is a combination of application B, D and E).

The problem of automatically matching and composing applications has been reviewed in Evren Sirin and Bijan Parsia; “Planning for semantic web services.” In Semantic Web Services Workshop at 3^{rd} International Semantic Web Conference (ISWC2004), hereinafter Sirian 2004; and Qiang Yang and Alex Y. M. Chan; Delaying Variable Binding Commitments in Planning, hereinafter Yang. Many of these approaches use either domain independent ontologies such as thesaurus or domain dependent ontologies for determining semantic similarity. Some work has also been done to combine these approaches to achieve better relevancy (see e.g., and T. Syeda-Mahmood, G. Shah. R. Akkiraju, A. Ivan, and R. Goodwin; “Searching Service Repositories by Combining Semantic and Ontological Matching.” Third International Conference on Web Services (ICWS), Florida, July 2005, hereinafter Syeda-Mahmood et al.).

For accomplishing compositions, use of recursive chaining algorithms (see, e.g., McIlraith S. and Son T. C and Zeng H. 2001, Semantic Web Services. IEEE Intelligent Systems, Special Issue on the Semantic Web; March/April. Number 2, Pages 46-53 Volume 16, hereinafter Mc.Ilraith et al.) or AI planning approaches (Sirin 2004) have been suggested.

Mixing planning with reasoning has been attempted by Yang and most recently by Sirin 2004. However, this body of work primarily looks at mixing planning with reasoning methods that work on domain-dependent ontologies.

### SUMMARY

Combining artificial intelligence (AI) planning algorithms or other algorithms with semantic matching and reasoning approaches has received no attention so far. The advantage of using semantic matching approach with planning is that the semantic matching permits for the selection of substitutable/alternative plans thereby increasing the recall (e.g., the percentage of the total relevant documents in a repository retrieved by a search). This gives the user additional choice of solutions in making the final selection of suitable applications to meet his/her request. To the knowledge of the inventors, no one has attempted using a semantic matching with planning to automate the matching and composition of application interfaces.

A system and method for composing application services includes an indexing module configured to index words in a request and available application descriptions to create a semantic similarity map. A semantic matcher is configured to determine semantic similarity between concepts/terms in both domain-independent and domain-specific ontologies for the semantic similarity map. A prefiltering module is configured to determine candidate compositions for the request based on the semantic similarity map and the available descriptions. A metric guided composition method is configured to run algorithms to generate a set of alternative compositions by determining which applications can be composed with which others using the semantic similarity map.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for composing software applications by combining semantic matching and planning algorithms in accordance with one illustrative embodiment;

FIG. 2 is a block diagram showing a method for composing software applications by combining semantic matching and planning algorithms in accordance with another illustrative embodiment;

FIG. 3 is a block diagram showing an example in a text analysis domain using a plurality of annotators in accordance with an illustrative embodiment;

FIG. 4 is plot of number of services versus threshold in accordance with one illustrative embodiment;

FIG. 5 is plot of cost versus plans in accordance with one illustrative embodiment;

FIG. 6 is plot of recall versus threshold in accordance with one illustrative embodiment; and

FIG. 7 is plot of number of plans versus a number of states in accordance with one illustrative embodiment.

### DETAILED DESCRIPTION OF PREFERRED EMBODIMENTS

Embodiments of the present disclosure provide systems and methods for the composition of software applications. The systems and methods combine domain-independent cues with domain-dependent cues to generate software application compositions.

The use of planning for automated and semi-automated composition of web services has enormous potential to reduce costs and improve quality in inter and intra-enterprise business process integration. Composing existing Web services to deliver new functionality is a difficult problem as it involves resolving semantic, syntactic and structural differences among the interfaces of a large number of services. Unlike most planning problems, it cannot be assumed that web services are described using terms from a single domain theory.

While service descriptions may be controlled to some extent in restricted settings (e.g., intra-enterprise integration), in web-scale open integration, lack of common, formalized service descriptions prevent the direct application of standard planning methods.

Novel systems and method are described herein to compose applications, such as, web services in the presence of semantic ambiguity by combining semantic matching and artificial intelligence (AI) planning algorithms or other algorithms. Embodiments described herein use cues from domain-independent and domain-specific ontologies to compute an overall semantic similarity score between ambiguous terms. This semantic similarity score is used by AI planning algorithms to guide the searching process when composing services. In addition, semantic and ontological matching is integrated with an indexing method, which may be referred to as attribute hashing, to enable fast lookup of semantically related concepts.

Experimental results conducted by the inventors indicate that planning with semantic matching produces better results than planning or semantic matching alone. The solution is suitable for semi-automated composition tools or directory browsers.

Enterprise application integration is among the most critical issues faced by many companies today. The problem is caused by the way systems are developed in large enterprises, i.e., over different periods of time, for different initial purposes, by different organizations, and with different structures, interfaces and vocabulary. The infrastructure also evolves through acquisitions, mergers and spin-offs. This leads to substantial heterogeneity in syntax, structure and semantics.

In this setting, companies are under constant pressure to be flexible, to adapt to the changes in the market conditions while keeping their IT expenses under control, and to implement integration projects without delay.

One important aspect of quickly implementing new integration projects involves the ability to find and reuse as much of the existing functionality as possible and create new functionality only where needed. In the context of service-oriented architectures, this translates into the technical challenges of discovery, reuse and composition of services.

In implementing service-oriented architectures, Web services are becoming one important technological component. Web services offer the promise of easier system integration by providing standard protocols for data exchange using XML messages and a standard interface declaration language such as the Web Service Description Language (WSDL 2001). The loosely coupled approach to integration by Web services provides encapsulation of service implementations, making them suitable for use with legacy systems and for promoting reuse by making external interfaces explicitly available via a WSDL description.

However, this still does not address the vexing issue of dealing with heterogeneity in service interface definitions. For example, what one service interface in one system may encode as itemID, dueDate, and quantity may be referred to by another service interface in a different system as UPC (Universal Part Code), itemDeliveryTime and numItems. At the heart of data and process integration is the need to resolve these types of similarities and differences among various formats, structures, interfaces and ultimately vocabulary.

Developing tools to help resolve these types of syntactic, structural and semantic similarities and differences is key to keeping IT expenses in check. Aspects of the present invention address problems of identifying the appropriate services (e.g., Web services) for implementing a function from a large collection of available services. Specific focus is given to the problem of Web service composition in the absence of a common domain model and where the functionality of multiple services has to be composed to achieve a valid implementation.

Web services matching and composition have become a topic of increasing interest in the recent years with the gaining popularity of Web services. Two main directions have emerged. The first direction explores the application of information retrieval techniques for identifying suitable services in the presence of semantic ambiguity from large repositories. The second direction investigates the application of AI planning algorithms to compose services.

In the latter approach, Web services are framed as actions that are applicable to states and the inputs and outputs of services are modeled as preconditions and effects of actions. However, these two techniques have not been combined to achieve compositional matching in the presence of inexact terms, and thus improve recall. Novel approaches to compose Web services in the presence of semantic ambiguity using a combination of semantic matching and AI planning algorithms is herein disclosed.

Specifically, domain-independent and domain-specific ontologies are employed to determine the semantic similarity between ambiguous concepts/terms. The domain-independent relationships are derived using a thesaurus after tokenization and part-of-speech tagging. The domain-specific ontological similarity is derived by inferring the semantic annotations associated with Web service descriptions using an ontology. Matches due to the two cues are combined to determine an overall similarity score.

This semantic similarity score is used by AI planning algorithms in composing services. In addition, semantic and ontological matching is integrated with an indexing method, or attribute hashing, to enable fast lookup of semantically related concepts. By combining semantic scores with planning algorithms or any other algorithmic approach (e.g., graph planning algorithms, linear programming models etc.) to create compositions, better results can be achieved than obtained using a planner or matching alone.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

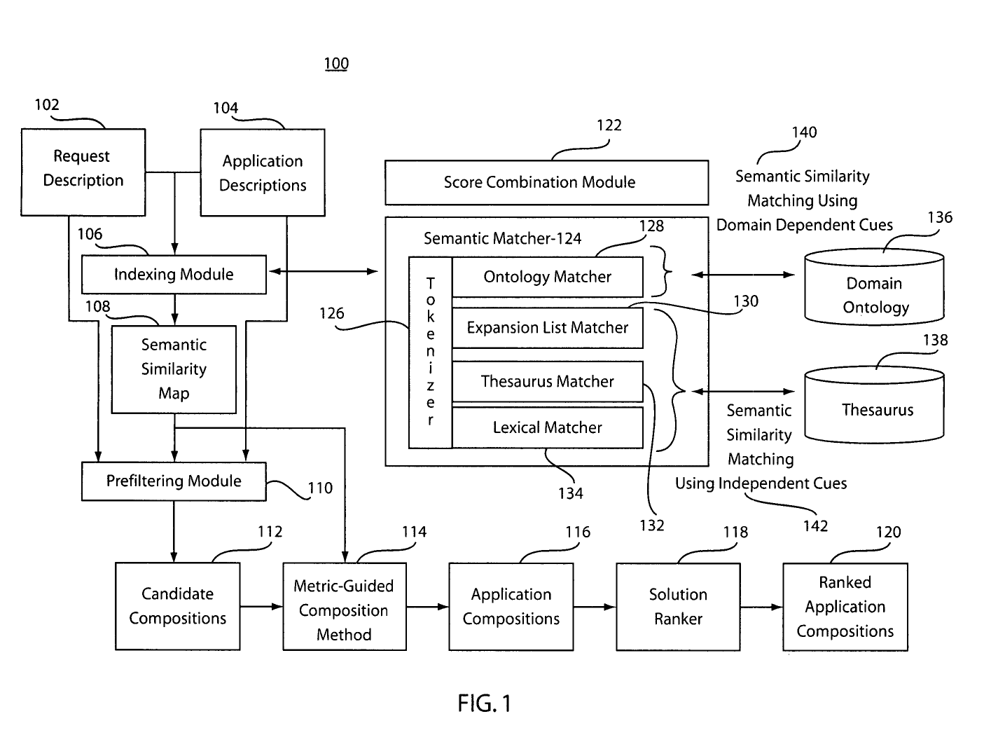

Referring now to the drawings in which like numerals represent the same or similar elements and initially to FIG. 1, a block/flow illustratively shows a system/method 100 for composing software application based on semantic matching and a planning algorithm, e.g., an AI planning algorithm. This embodiment includes automatically finding suitable software applications for implementing a function from a large collection of available applications. Semantic matching and other approaches can be combined to accomplish application discovery and composition. In this illustrative embodiment, AI planning is combined with semantic matching to illustrate aspects of the present invention. Other planning algorithms, linear programming models, other models, etc. may also be employed.

In block 102, a request may be made by a user or made automatically by a computer device or server for an application description. This description may include an application interfaces, however, other information may be included and/or employed. The application interface description may include input/outputs needed to service a request. Application descriptions 104 (e.g., application interface descriptions) are made available to the system to permit description of available applications based upon the requests made.

Semantic matching includes using both domain-independent and domain-specific ontologies to find matching application descriptions. An indexing module 106 indexes all keywords in the request (102) as well as all the available application interface descriptions (104). This is achieved by using the services of a semantic matcher 124. Semantic matcher 124 uses both domain-independent and domain-specific models to discover similarity between application interface concepts. These models may include an ontology matcher 128 for domain dependent cues 140. For domain independent cues, an expansion list matcher 130, a thesaurus matcher 132 and a lexical matcher 134 may be employed. Other models and matchers are also contemplated and may be employed based on the application and the system criteria.

The domain-independent relationships are derived using a thesaurus 138 (e.g., an English thesaurus) after tokenization by a tokenizer 126 and part-of-speech tagging by lexical matcher 134 in the semantic matcher 124. For example, customer and client would be considered a match by the thesaurus matcher 132 because they are synonyms. Words such as custID get expanded to CustomerIdentifier and are matched separately by the expansion list matcher 130. Stop words such as and, the, etc. get filtered out by a lexical matcher 134 or other device.

Tokenizer 126 splits words or text into tokens. A token can be a symbolic representation of a word or number, for example, a name, number or acronym can be identified as a token. Rules are applied to split text into tokens (e.g., using separation characters, underscores, dashes, capital letters, etc.). The tokenizer 126 identifies tokens in words in accordance with a set of rules.

The domain-specific similarity is derived by inferencing the semantic annotations associated with application interface descriptions using ontology matcher 128. For example, using a domain model that represents the relationships such as UPC is a subClassOF EAN Code say in a retail industry domain model, an application interface that takes an EAN code can be matched with that of another that expects a UPC Code. Similarly, if UPC Version E is a typeOf UPC Code, it can be inferred that a relationship exists between UPC Version E and EAN Code via UPC Code and use this relationship during mapping in block 108.

Matches due to the two cues 140 and 142 are combined to determine an overall semantic similarity score. This semantic similarity score is used in a planning stage to obtain compositions including not only of application interface descriptions that directly match the given request but also of those that are semantically similar. The advantage of using semantic matching approach with planning is that the semantic matching allows for the selection of substitutable/alternative plans thereby increasing the recall (e.g., the percentage of the total relevant documents in a repository retrieved by the search). This gives the user additional choices of solutions in making the final selection of suitable applications to meet her request.

Depending on the level of inferencing that is used, semantic similarity scores can be assigned. For example, a concept that can be inferred with a single SubClassOF relation is a closer match than a match that needs multiple levels of subClassOf relations. Matches due to the two cues (domain-independent cues 142 and domain-specific 140) are combined by a score combination module 122 to determine an overall semantic similarity score. By combining multiple cues, better relevancy results can be obtained for service matches from a large repository, than could be obtained using any one cue.

The result of indexing in indexing module 106 is a semantic similarity map 108. This map 108 is organized for efficient retrieval of related concepts and their scores for a given concept. This map 108 is passed on to a prefiltering module 110 along with the request 102 and available interface descriptions 104. The prefiltering module 110 uses smart techniques to obtain a candidate set 112 of interface descriptions from the given set of available interface descriptions 104 from which compositions can be created. Several techniques could be used to achieve this. For example, prefiltering module 110 could use a backward searching algorithm to find candidate interface descriptions from which compositions 112 can be created.

Prefiltering module 110 uses the semantic similarity map 108 to determine whether a given interface description concept is a match to another concept in a different interface description. These candidate application interfaces 112 are passed to a metric-guided composition method 114 (e.g., a metric planner) along with the semantic similarity map 108. Metric-guided composition method 114 runs the algorithms and generates a set of alternative compositions or application compositions 116 using metrics, such as cost, number of compositions, etc. In determining which interfaces can be composed with which others, the metric-guided composition method 114 uses the semantic similarity map 108.

The alternative compositions 116 are ranked by a ranking module 118. The ranking module 118 can use various criteria to rank the solutions. For example, one way to rank the criteria would be to sort the compositions in ascending order of their cost or semantic distance (the opposite of semantic score). The output is a ranked list of application compositions 120.

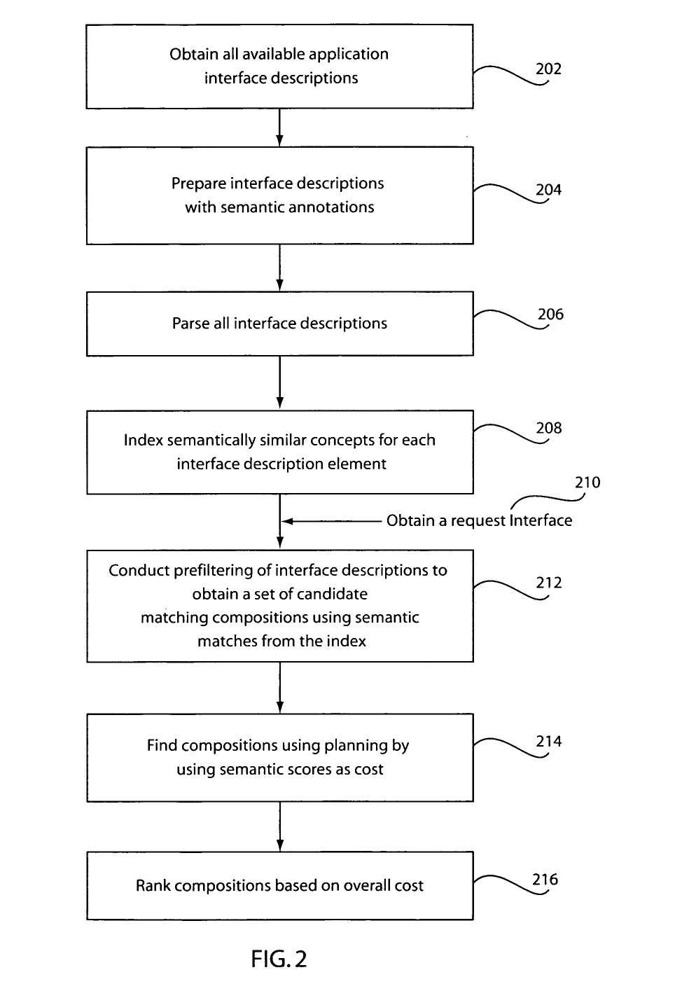

Referring to FIG. 2, the components and the control flow of an illustrative embodiment is illustratively shown. Service representation is provided by obtaining all available application interface descriptions in block 202. This may involve preparing interface description with semantic annotations (e.g., preparing Web Services with semantic annotations and readying the domain dependent and independent ontologies) in block 204. In block 206, all interface descriptions are parsed for indexing.

In block 208, term relationship indexing is performed. Semantically similar concepts for each interface description element are indexed. For example, the available Web services in the repository are parsed, processed and an index including related terms/concepts referred to in the service interface descriptions is created for easy lookup. This is achieved using the services of a semantic matcher (124, FIG. 1) which uses both domain-independent and domain-specific cues to discover similarity between application interface concepts. The result of indexing is a semantic similarity map (108, FIG. 1).

This semantic similarity map is capable of returning a semantic score for a given pair of concepts by combining the individual scores from domain-dependent and domain-independent sources. This map is organized for efficient retrieval of related concepts and their scores for a given concept.

In block 210, an interface (or application is requested. In accordance with the request, in block 212, prefiltering is performed. Once indexing of related concepts is accomplished, prefiltering obtains a list of candidate matching services for a given request. This is done by a prefiltering module (110, FIG. 1). The prefiltering module uses smart techniques to obtain a candidate set of interface descriptions from the given set of available interface descriptions from which compositions can be created.

In block 214, compositions are generated. The candidate application interfaces are passed to a metric planner (114, FIG. 1) along with the request interface description 210, and the semantic similarity map. The metric planner runs partial order planning algorithms and generates a set of alternative compositions from the given candidate set for the given request interface description. To determine which interfaces can be composed with which others, metric planner uses the semantic similarity map using semantic scores as costs.

In block 216, solution ranking is performed. The alternative compositions are ranked by a ranking module (118, FIG. 1).

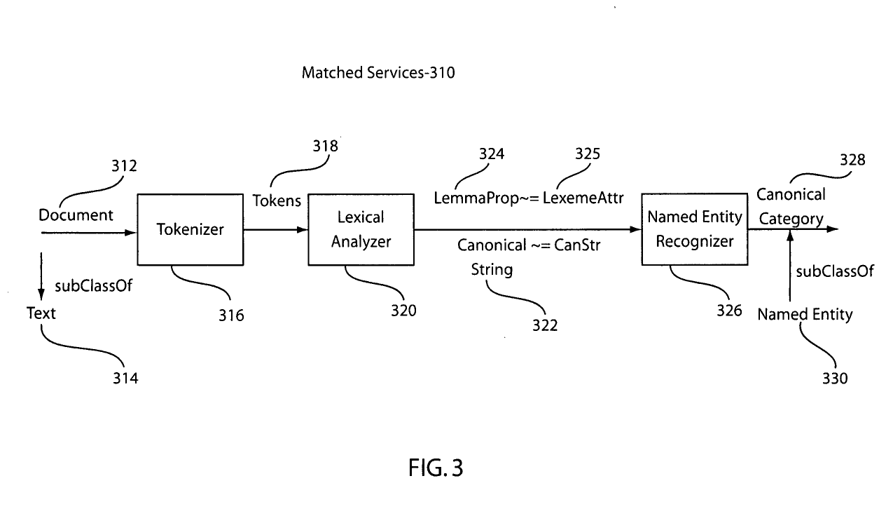

Referring to FIG. 3, composing existing Web services to deliver new functionality is a need in many business domains. A scenario is presented from the knowledge management domain to illustrate the need for (semi) automatic composition of Web services and exemplarily highlight how semantic matching combined with planning could yield better results.

Just as with any software development process, annotators are written by multiple authors at different periods of time. These authors could have used different terminology to describe the interfaces of their annotators. In addition, domain specific annotators could have been acquired from external sources (via licensing, acquisition etc). So, it is unlikely that the authors use a common set of terms to name services (annotators in this scenario) and parameters. This creates semantic ambiguity that, if unresolved, could lead to poor management of available applications.

Matched service 310 provides text or speech analysis to transform unstructured text/speech into structured information, and to use this information to support higher-level processes of text search, mining, and discovery. This involves writing annotators or software programs that can interpret text 314 in text documents 312, parse them, identify phrases, grammar, classify text and eventually create structure from the unstructured information. Some annotators are general purpose while the others are specific to various application domains all of which could be made available as Web services, etc. Some annotators sample general purpose annotators and include annotators such as a tokenizer 316, which identifies tokens 318, a lexical analyzer 320, which identifies parts of speech, a named entity recognizer 326, which identifies references to people and things, etc.

Annotators from the biological domain may include BioAnnotator, which identifies biological terms, ChemFrag, which identifies biologically significant chemical structures, DrugDosage, which recognizes drug applications and dosages etc. The functionality of multiple annotators may be combined to meet a specific request. For example, if a user would like to identify names of authors in a given document, annotators Tokenizer 316, LexicalAnalyzer 320 and NamedEntityRecognizer 326 could be composed to meet the request. Tokenizer annotator 316 tokenizes a given document. LexicalAnalyzer 320 performs lexical analysis on tokens 318. NamedEntityRecognizer annotator 326 identifies and classifies tokens based on their lexical properties (322, 324) into the names of peoples, places and things (328, 330). Semantic matcher 124 may include these or other annotators or matchers.

For example, a term lexemeAttrib may not match with lemmaProp 324 unless the word is split into lexeme and Attrib and matched separately. Using a domain-dependent ontology one can infer that a lemma in linguistic context is a canonical form 322 of a lexeme and therefore the term lemma could be considered a match to the term lexeme.

Abbreviation expansion rule can be applied to the terms Attrib and Prop to expand them to Attribute and Property. Then, a consultation with a domain-independent thesaurus such as WORDNET™ dictionary can help match the term Attribute with Property since they are listed as synonyms. Putting both of these cues together, one can match the term lexemeAttrib with lemmaprop. In the absence of such semantic cues, two services that have the terms lexemeAttrib and lemmaProperty as part of their effects would go unmatched during planning thereby resulting in fewer results which adversely impacts recall.

Benefits of the present embodiments include the ability to compose plans in the presence of inexact terms. This is expected to improve the recall of results. (Recall is the ratio of the number of relevant services (compositions) retrieved to the total number of relevant services/compositions in the repository, and can be expressed as a percentage).

The following is an explanation of a service representation in accordance with an illustrative embodiment of the system of FIG. 1. The terms and features described below are illustrative of features described with reference to FIG. 1. The functionality of services is represented using the Web Services Description Language (WSDL). Domain independent dictionaries can be used to match the terms used in the WSDL document. However, in order to use domain-specific ontological information, references to the ontology need to be present in the service description. The standard WSDL specification does not have a mechanism to denote such ontological information and hence is augmented before such information can be used to determine matching services. The subject of semantic annotation is an active area of research in the semantic web community with languages such as OWL-S, WSMO, WSDL-S, etc. The WSDL-S specification is adopted herein due to its simplicity. Domain-specific ontologies using OWL are created. Using the WSDL-S specification, elements are annotated in the WSDL file using the attribute wssem:modelReferences. Its value is an OWL ontology concept specified by the name of the ontology and the relevant ontological term. After parsing the WSDL documents, a generalized schema object is created internally to capture the service definitions, portTypes and other information.

Term relationship indexing (106) will be described and includes (a) how semantic matching of service interface descriptions can be accomplished by using both domain-dependent and domain-independent cues, (b) how matches due to the two cues (domain-independent and domain-specific) are combined by the score combination module (122) to determine an overall semantic similarity score, and (c) how efficient indexing is performed.

Related terms using domain independent ontologies are to be determined. Finding semantic relationships between attributes is difficult because (1) Attributes could be multi-word terms (e.g. CustomerIdentification, PhoneCountry, etc.) which need tokenization. Any tokenization should capture naming conventions used by programmers to form attribute names; (2) Finding meaningful matches might need to account for senses of the word as well as their part-of-speech through a thesaurus; (3) Multiple matches of attributes should be taken into account; and (4) the structure/type information should be exploited so that operations match to operations, messages to messages, etc.

Name semantics may be captured using multi-term query attributes which are parsed into tokens. Part-of-speech tagging and stop-word filtering (124) is also performed. Abbreviation expansion is done for the retained words if necessary, and then a thesaurus is used to find the similarity of the tokens based on synonyms. The resulting synonyms are assembled back to determine matches to candidate multi-term word attributes of the repository services after taking into account the tags associated with the attributes. For example, customer and client would be considered a match because they are synonyms. CustID is matched with ClientNum because words such as custID get expanded to CustomerIdentifier and ClientNum gets expanded to ClientNumber and are matched separately (Cust with Client and ID with Num). Stop words such as and, the, etc. are filtered out.

A thesaurus (e.g., WORLDNET™) (138) may be employed to find matching synonyms to words. Each synonym is assigned a similarity score based on the sense index, and the order of the synonym in the matches returned. The result of this semantic matching process is that a given pair of concepts is given a semantic score based on these domain-independent cues (142).

The semantic score is computed as follows. Consider a pair of candidate matching attributes (A, B) from the query and repository services respectively. These matching attributes could be a pair of inputs to be matched from a service request and an available service from a repository. Let A, B have m and n valid tokens respectively, and let S_{yi} and S_{yj} be their expanded synonym lists based on domain-independent ontological processing. Consider each token i in source attribute A to match a token j in destination attribute B where iεS_{yi} and jεS_{yi}. Let h tokens have a match. Then, the semantic similarity between attributes A and B is then given by: M_{sem,}=min{h/n, h/m}. This use of the ratio of matched to total terms permits dealing with services that have vastly different numbers of parameters.

Finding related terms using domain-specific ontologies. A semantic network-based ontology management system known as SNOBASE may be employed. This management system offers DQL-based Java API for querying ontologies represented in OWL. The OWL-specified ontologies loaded into SNOBASE are parsed to populate its internal data store with facts and instances. The engine models four different types of relationships: (1,2) subClassOf(A,B), subClassOf(B,A)—which is essentially superClassOf, (3) type (A,B)—which is instanceof, and (4) equivalenceClass(A,B) are modeled where A and B are two given concepts. A simple scoring scheme may be used to compute distance between related concepts in the ontology. subClassOf, typeof, are given a score of 0.5, equivalentClass gets a score of 1 and no relationship gets a score of 0. The discretization of the score into three values (0, 0.5, 1.0) gives a coarse idea of semantic separation between ontological concepts.

This score between a given two concepts is represented as Mₒₙₜ. More refined scoring schemes are possible, but the current choice works well in practice without causing a deep semantic bias. Given a domain-specific ontology and a query term, the related terms in an ontology are found using rule-based inferences. In the SNOBASE system employed, IBM's ABLE engine for inferences.

The ABLE library includes rule-based inference using Boolean and fuzzy logic, forward chaining, backward chaining etc. The result of this domain-dependent ontology based inferencing is that a given pair of concepts is given a semantic score based on these domain-dependent cues (140).

Once semantic scores from domain-independent and domain-dependent cues are obtained, these individual scores are then combined to obtain an overall semantic score for a given pair of concepts. Several schemes such as winner-takes-all, weighted average could be used to combine domain-specific and domain-independent cues for a given attribute. These schemes are configurable. The default scheme may be winner-takes-all, where the best possible score (ontology-wise or semantic-matching-wise) is taken as the match score for a given pair of attributes. For each potential matching attribute pairs, let Mₛₑₘ be the matching score using semantic matching. Let Mₒₙₜ be the matching score using ontological matching. Then, the combined score is: M=max{Mₛₑₘ, Mₒₙₜ}.

With the current approach, all service attributes would have to be searched for each query service to find potential matches and to assemble the overall match results. Attribute hashing may be performed as an efficient indexing scheme (106) that achieves desired savings in search time.

To understand the role of indexing, consider a service repository of 500 services. If each service has about 50 attributes (quite common for enterprise-level services), and 2 to 3 tokens per word attribute, and about 30 synonyms per token, the semantic matching alone would make the search for a query of 50 attributes easily around 50 million operations per query! Indexing of the repository schemas is, therefore, one important consideration to reducing the complexity of search. Specifically, if the candidate attributes of the repository schemas can be directly identified for each query attribute without linearly searching through all attributes, then significant savings can be achieved.

One idea in attribute hashing can be described as follows. Let ‘a’ be an entity derived from a repository service description. Let F(a) be the set of related entities of ‘a’ in the entire service repository (also called feature set here). In the case of domain-independent semantics, ‘a’ refers to a token and F(a) is the set of synonyms of ‘a’. In the case of ontological matching, ‘a’ refers to an ontological annotation term, and F(a) are the ontologically related concepts to ‘a’ (e.g. terms related by subclass, equivalenceClass, is-a, etc. relationships).

Given a query entity q derived from a query service Q, q is related to a if qεF(a). Thus, instead of indexing the set F(a) using the attribute ‘a’ as a key as may be done in normal indexing, the terms in the set F(a) are used as keys to index a hash table and record ‘a’ as an entry in the hash table repeatedly for each such key. The advantage of this operation is that since qεF(a), q is indeed one of the keys of the hash function. If this operation is repeated for all entities in the service repository, then each hash table entry indexed by a key records all entities whose related term set includes the key.

Thus, indexing the hash table using the query entity q directly identifies all related entities from the service repository without further search! This is one important concept in attribute hashing. This may be done at the cost of redundant storage (the entity ‘a’ is stored repeatedly as an entry under each relevant key). However, with the growth of computer memory, storage is a relatively inexpensive tradeoff.

The prefiltering module (110) selects a set of candidate pools of services from which compositions can be accomplished. If the number of services in the repository is relatively small (of the order of dozens), then prefiltering may not be necessary. However, in data warehousing types of scenarios or in asset reuse scenarios, there could be hundreds of interfaces from which suitable applications have to be constructed; thus, obtaining a manageable set of candidate services via filtering is considerable to returning results in reasonable amount of time.

As with any filtering process, there is the possibility of filtering out some good candidates and bringing in bad candidates. However, prefiltering can reduce the search space and permit planning algorithms to focus on a viable set.

A simple backward searching algorithm may be employed to select candidate services in the prefiltering stage. The algorithm works by, first, collecting all services that match at least one of the outputs of the request—denoted as S₁1, S₁2, S₁3 . . . S₁n where n is the number of services obtained and S₁ denotes services collected in step 1. Let S₁i represent a service collected from step 1 where 1≦i≦n . . . . Then, for each service S₁i, collect all those services whose outputs match at least one of the inputs of S₁i. This results in a set of services added to the collection—denoted as S₂1, S₂2, S₂3 . . . S₂M where m is the number of services obtained in step 2. This process of collecting services is repeated until either a predefined set of iterations are completed or if at any stage no more matches could be found. The criteria for filtering could have significant influence on the overall quality of results obtained.

One can experiment with the criteria to fine-tune the prefiltering module to return an optimal set of candidate pools of services. The prefiltering module (110) uses the semantic similarity map obtained from the indexing stage to determine whether a given interface description concept is a match to another concept in a different interface description.

The set of candidate services (112) obtained from the prefiltering step are then presented to the metric planner. A planning problem P is a 3-tuple <I, G, A> where I is the complete description of the initial state, G is the partial description of the goal state, and A is the set of executable (primitive) actions. A state T is a collection of literals with the semantics that information corresponding to the predicates in the state holds (is true). An action Aᵢ is applicable in a state T if its precondition is satisfied in T and the resulting state T′ is obtained by incorporating the effects of Aᵢ. An action sequence S (called a plan) is a solution to P if S can be executed from I and the resulting state of the world contains G. Note that a plan can include none, one or more than one occurrence of an action Aᵢ from A. A planner finds plans by evaluating actions and searching in the space of possible world states or the space of partial plans.

The semantic distance represents an uncertainty about the matching of two terms and any service (action) composed due to their match will also have uncertainty about its applicability. However, this uncertainty is not probability in the strict sense of a probabilistic event which sometimes succeeds and sometimes fails. A service composed due to an approximate match of its precondition with the terms in the previous state will always carry the uncertainty. Hence, probabilistic planning is not directly applicable and it has been chosen to represent this uncertainty as a cost measure and apply metric guided composition determination (114) (e.g., metric planning) to this problem.

A metric planning problem is a planning problem where actions can incur different costs. A metric planner finds plans that not only satisfy the goal but also with least cost. Note that probabilistic reasoning can be modeled in this generalized setting.

The changes needed in a standard metric planner to support planning with approximate distances will be described. Current embodiments use planning in the state of world states (state space planning), but it are applicable to searching in space of plans as well.

Table 1 below presents a pseudo-code template of a standard forward state-space planning algorithm (ForwardSearchPlan):

TABLE 1
ForwardSearchPlan(I, G, A)

| | |
|---|---|
| 1. | If I ⊃ G |
| 2. | Return { } |
| 3. | End-if |
| 4. | Nᵢₙᵢₜ.sequence = { }; Nᵢₙᵢₜ.state = I |
| 5. | Q = { Nᵢₙᵢₜ } |
| 6. | While Q is not empty |
| 7. | N = Remove an element from Q (heuristic choice) |
| 8. | Let S = N.sequence; T = N.state |
| 9. | For each action Aᵢ in A (all actions have to be attempted) |
| 10. | If precondition of Aᵢ is satisfied in state T |
| 11. | Create new node N′ with: |
| 12. | N′.state = Update T with result of effect of |
| Aᵢ and | |
| 13. | N′.sequence = Append(N.sequence, Aᵢ) |
| 14. | End-if |
| 15. | If N′.state ⊃ G |
| 16. | Return N′ ;; Return a plan |
| 17. | End-if |
| 18. | Q = Q U N′ |
| 19. | End-for |
| 20. | End-while |
| 21. | Return FAIL ;; No plan was found. |

The planner (ForwardSearchPlan) creates a search node corresponding to the initial state and inserts it into a queue. It selects a node at 7. from the queue guided by a heuristic function. It then tries to apply actions at 10. whose preconditions are true in the corresponding current state. The heuristic function is a measure to focus the search towards completing the remainder part of the plan to the goals.

To support planning with partial semantic matching, changes at 7. and 10. of Table 1 are made. The heuristic function has to be modified to take the cost of the partial plans into account in addition to how many literals in the goals have been achieved. For Step 10, the notion of action applicability is generalized. Conventionally, an action Aᵢ is applicable in a state T if all of its preconditions are true in the state. With semantic distances, a precondition is approximately matching the literals in the state. A number of choices are available for calculating the plan cost. For example, in matching of an action's precondition with the literals in the state, which semantic distance should be selected? The first one, the least distance, or any other possibility may be used. Another example in selecting the semantic cost of the action, is how the contribution of the preconditions are aggregated. The minimum of the distances, maximum, or any other aggregate measure may be used. In computing the semantic cost of the plan, how is the contribution of each action in the plan computed? Adding the costs of the actions, take their products, or any other function may be used.

A metric planner has been implemented in the Java-based Planner4J framework. Planner4J provides for planners to be built exposing a common programmatic interface while they are built with well-tested common infrastructure of components and patterns so that many of the existing components can be reused. Planner4J has been used to build a variety of planners in Java and it has eased their upgrade and maintenance while facilitating support for multiple applications. The planner can be run to get all plans within a search limit, different plans by changing the threshold for accepting semantic distances and by experimenting with various choices of cost computations for the actions and plans.

The ranking module (118) can use various criteria to rank the solutions. For example, one way to rank the criteria would be to sort the compositions in ascending order of the overall cost of the plan. Another way is to rank the compositions based on the length of the plan (e.g., the number of services in the plan). A multidimensional sorting approach could be used to sort based on both cost and the length of the plan. Multiplying the normalized costs is another approach, and may bring in notions of probabilistic planning and enable taking both cost and length into account at once. These approaches are configurable.

Experimental Results

The following demonstrates the value of combining domain-independent and domain-dependent semantic scores with a metric planner when composing Web services. For this, several experiments were run on a collection of over 100 Web services in three domains: (1) Text analysis—20 WSDLs that provide text analysis services, (2) Alphabet—7 WSDLs manually built to test the correctness of the planner when the relationships between services are very complex, and (3) Telco—75 WSDLs defined from a real life telecommunication scenario.

For clarity, only the results for the first domain are reported, as the other two domains presented similar behavior. The planner performance is measured through the recall function (R), defined as the ratio between the number of direct plans retrieved by the planner and the total number of direct plans in the database. A direct plan is defined as a correct plan (i.e., it reaches the goal state, given the initial state) with a minimum number of actions (i.e., discard plans that contain loops or redundant actions).

The definition of the recall function was due to an observation made when contrasting the results returned by a search engine in the information retrieval domain and the ones returned by a planner in the Web Services domain. In Web search, recall is defined by relevancy. A search query that is looking for ‘Soprano’ could find results consisting of SOPRANOS™ (the HBO™ show) as well as information on sopranos from Wikipedia, etc. Depending on what the user meant, the user would find one of the two categories of search results to be more relevant than the others.

However, when composing Web services using a planner, the notion of relevancy needs to be interpreted slightly differently. Since planners are goal directed, and the semantic matches are often driven by closely related terms in the domain-independent and domain-dependent ontologies, all the results obtained were found to be relevant. Therefore, relevancy was redefined as the direct matches the present system is able to find with minimal length (fewer number of services composed to meet the request) without redundancies in the experiments.

For example, in the text analysis example, one of the direct plans is the sequence of: Tokenizer (316), Lexical Analyzer (320) and NamedEntityRecognizer (326) (FIG. 3) services. Depending on the number of states, the system is permitted to run, the system finds compositions that include sequences such as: Tokenizer, LexicalAnalyzer, Tokenizer, and NamedEntityRecognizer. In this plan, the second Tokenizer is redundant.

The total number of direct plans in the database was computed by manually performing an exhaustive search and counting all plans. The number of direct plans retrieved by the planner was computed by intersecting the set of planners found by the planner with the set of direct plans defined by the database.

The experiments were executed by varying the following levers in the system and observing the planner performance: (a) the semantic threshold (ST) allows different levels of semantic ambiguity to be resolved (b) the number of state spaces explored (#SS) limits the size of the searching space (c) the cost function (CF), defined as [w*semantic distance+(1−w)*length of the plan] where 0≦w≦1, directs the system to consider the semantic scores alone or the length of the plan alone or a combination of both in directing the search.

The following four experiments were run to measure the performance. 1. Metric Planner alone vs. the present system; 2. The present system: f(ST) where CF, and #SS are constants; 3. The present system: f(#SS) where CF, and ST are constants; and 4. The present system: f(#CF) where ST, #SS are constants.

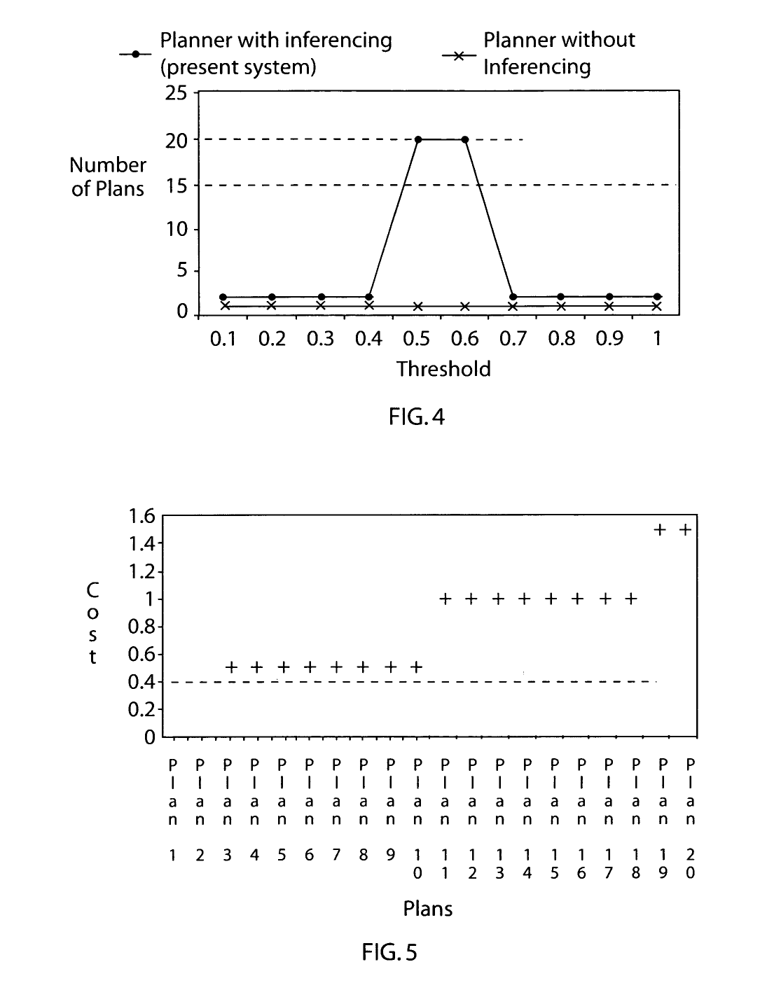

Experiment 1: In this experiment, our hypothesis was that a planner with semantic inferencing would produce more relevant compositions than a planner alone. The intuition is that the semantic matcher allows concepts such as lexemeAttrib and lemmaProp to be considered matches because it considers relationships such as word tokenization, synonyms, and other closely related concepts (such as subClassOf, typeOf, instanceof, equivalentClass) defined by the domain ontologies; such relationships are not usually considered by the planner. As FIG. 4 shows, the present system finds more relevant results than a classic metric planner, thus confirming the hypothesis. The costs of all plans retrieved by the present system are shown in FIG. 5 (where the threshold=0.6). The increased number of solutions is more prevalent with certain semantic thresholds.

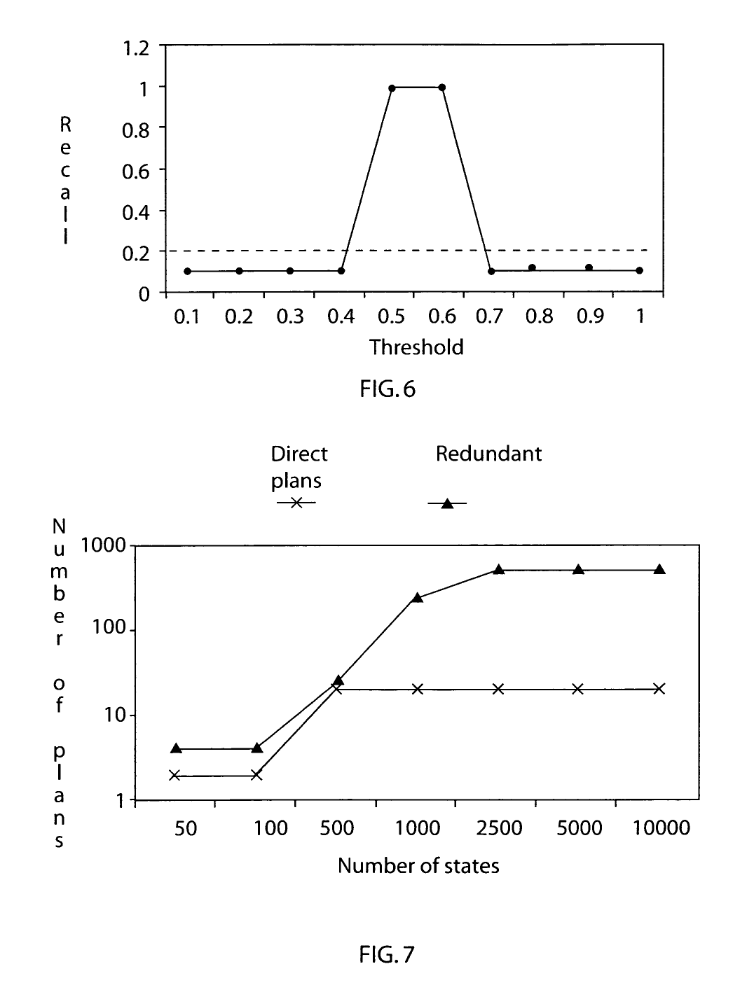

In experiment 2, the semantic threshold was varied for a given number of state spaces to be explored (1000) and a given cost function for each domain (w=0.5). As the semantic threshold increases, only those concepts that are above the threshold would be considered matches; therefore, it was expected that the number of results produced by the planner would decrease and vice versa. While this is confirmed by the results in FIG. 6, it was noticed that as the semantic threshold decreased, more and more loosely related concepts are considered matches by the semantic matcher. This increased the number of services available for the planner to plan from, thereby increasing the search space.

For a given cost function and for a given number of state spaces to be explored, there is an optimal threshold. In most domains, this was found to be about 0.6.

In experiment 3, f (#SS) where CF, and ST are constants. Based on the insights from the second experiment, the number of state spaces was varied by keeping the weight w in cost function and semantic threshold at the optimal levels (w=0.5, and ST=0.6). The results of this experiment, as shown in FIG. 7, revealed that as the number of state spaces explored increases, embodiments of the present invention find more plans in general and more direct relevant plans than it could at the same ST and w.

TABLE 2: present embodiments' performance when changing the cost function.

| weight | direct | redundant | recall |
|---|---|---|---|
| 0 | 20 | 234 | 1 |
| 0.5 | 20 | 374 | 1 |
| 1 | 20 | 423 | 1 |

In experiment 4, f(#CF) where ST, #SS are constants. The weight in the cost function was varied to see how the quality of the plans generated is impacted. As weight approaches 1, the cost function gives less preference to length, therefore it is expected to see a larger number of longer plans (sometimes with redundancies) than those expected at lower weights and vice versa. The results illustrated in Table 2 confirm this.

Having described preferred embodiments of a system and method to compose software applications by combining planning with semantic reasoning (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system for composing application services, comprising:
an indexing module configured to index words in a request and available application descriptions to create a semantic similarity map;
a semantic matcher configured to determine semantic similarity between concepts/terms in both domain-independent and domain-specific ontologies for the semantic similarity map;
a prefiltering module configured to determine candidate compositions for the request based on the semantic similarity map and the available descriptions; and
a metric-guided composition method configured to run algorithms to generate a set of alternative compositions by determining which applications can be composed with which others using the semantic similarity map.

2. The system as recited in claim 1, wherein the semantic matcher includes a tokenizer configured to create tokens from words of the request.

3. The system as recited in claim 1, wherein the semantic matcher includes a thesaurus matcher to determine domain-independent relationships using a thesaurus.

4. The system as recited in claim 1, wherein the semantic matcher includes an expansion list matcher to expand abbreviated words for domain-independent relationships.

5. The system as recited in claim 1, wherein the semantic matcher includes a lexical matcher to determine parts of speech for domain-independent relationships.

6. The system as recited in claim 1, wherein the semantic matcher includes domain-specific ontological similarity derived by inferring semantic annotations associated with service descriptions using an ontology.

7. The system as recited in claim 1, further comprising a score combination module configured to combine matches due to domain-independent and domain-specific cues to determine an overall similarity score.

8. The system as recited in claim 1, further comprising a solution ranker configured to rank the alternative compositions in accordance with a criterion.

9. A method for composing service applications, comprising:
obtaining application descriptions;
preparing the descriptions with semantic annotations;
indexing semantically similar concepts for each description element, wherein similar concepts are determined using both domain-independent and domain-specific ontologies;
prefiltering the interface descriptions to obtain a set of candidate matching application compositions using semantic matches from the indexing; and
determining application compositions from the set using planning algorithms and semantic scores.

10. The method as recited in claim 9, wherein indexing semantically similar concepts includes semantic similarity matching using domain dependent cues and domain independent cues.

11. The method as recited in claim 10, wherein semantic similarity matching includes employing a thesaurus to determine domain-independent relationships.

12. The method as recited in claim 10, wherein semantic similarity matching includes employing an expansion list matcher to expand abbreviated words for domain-independent relationships.

13. The method as recited in claim 9, wherein semantic similarity matching includes employing a lexical matcher to determine parts of speech for domain-independent relationships.

14. The method as recited in claim 10, wherein semantic similarity matching includes domain-specific ontological similarity derived by inferring the semantic annotations associated with service descriptions using an ontology.

15. The method as recited in claim 9, further comprising combining scores of matches due to domain-independent and domain-specific cues to determine an overall semantic similarity score.

16. The method as recited in claim 9, further comprising ranking solutions to the application compositions in accordance with a criterion.

17. The method as recited in claim 9, wherein determining application compositions from the set using planning algorithms and semantic scores includes combining semantic matching including domain-dependent and domain-independent ontologies with planning techniques to achieve service compositions.

18. A computer program product comprising a computer useable medium including a computer readable program, wherein the computer readable program when executed on a computer causes the computer to perform the steps of:
obtaining application descriptions;
preparing the descriptions with semantic annotations;
indexing semantically similar concepts for each interface description element, wherein similar concepts are determined using both domain-independent and domain-specific ontologies;
prefiltering the descriptions to obtain a set of candidate matching application compositions using semantic matches from the indexing; and
determining application compositions from the set using planning algorithms and semantic scores.

19. The computer program product as recited in claim 18, wherein indexing semantically similar concepts includes semantic similarity matching using domain dependent cues and domain independent cues.

20. The computer program product as recited in claim 18, wherein semantic similarity matching includes employing a thesaurus, an expansion list matcher, and/or a lexical matcher to determine domain-independent relationships.

21. The computer program product as recited in claim 18, wherein semantic similarity matching includes domain-specific ontological similarity derived by inferring the semantic annotations associated with service descriptions using an ontology.

22. The computer program product as recited in claim 18, further comprising combining scores of matches due to domain-independent and domain-specific cues to determine an overall semantic similarity score.

23. The computer program product as recited in claim 18, further comprising ranking solutions to the application compositions in accordance with a criterion.

24. The computer program product as recited in claim 18, wherein determining application compositions from the set using planning algorithms and semantic scores includes combining semantic matching including domain-dependent and domain-independent ontologies with planning techniques to achieve service compositions.
